(19) United States
(12) Patent Application Publication
(10) Pub. No.: US 2025/0378365 A1
(43) Pub. Date: Dec. 11, 2025

(54) SYSTEMS AND METHODS FOR USER CLASSIFICATION USING MACHINE LEARNING

(71) Applicant: STRIPE, INC., South San Francisco, CA (US)

(72) Inventors: Michael Tashman, Jersey City, NJ (US); William Doughty, Richmond, CA (US); Eli Kollman, San Francisco, CA (US); John Stanton Haddock, New York, NY (US)

(21) Appl. No.: 18/734,951

(22) Filed: Jun. 5, 2024

(51) Int. Cl. G06N 20/00

(52) U.S. Cl. CPC G06N 20/00

(57) ABSTRACT

Systems and methods for classifying a user and issuing actions are disclosed. One method may include receiving a first score for a first characteristic associated with a user and a second score for a second characteristic associated with the user. The first and second scores may be evaluated for determining a first metric for the user. A criterion may be detected for reevaluating the first metric. Based on detecting the criterion, a first action and a timing of the first action may be selected for obtaining information associated with the user. The first action and timing of the first action may be configured to maximize accuracy of a prediction of a second metric and minimize a cost associated with the first action. The second metric may be generated based on the information obtained via the first action. A second action may be performed based on the second metric.

### BACKGROUND

Some businesses control their overall risk exposure by analyzing the riskiness of serving individual customers and selecting which services to offer to particular customers, or set limits to those service offerings, accordingly.

The above information disclosed in this Background section is only for enhancement of understanding of the present disclosure, and therefore it may contain information that does not form the prior art that is already known to a person of ordinary skill in the art.

### SUMMARY

The present disclosure is directed to systems and methods for computing a trusted user metric based on collected user information, and issuing interventions for obtaining information from the user, substantially as shown in and/or described in connection with at least one of the figures, as set forth more completely in the claims. Of course, the actual scope of the invention is defined by the appended claims.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 depicts a computing environment for user classification using machine learning according to one or more embodiments;

FIG. 2 depicts a block diagram of the transaction processing system according to one or more embodiments;

FIG. 3 depicts a flow diagram of a process for user classification and transaction processing according to one or more embodiments;

FIG. 4 depicts a flow diagram of a process for classifying a user according to one or more embodiments;

FIG. 5 depicts a flow diagram of a process for selecting an intervention according to one or more embodiments;

FIG. 6 depicts a graphical user interface (GUI) provided by a transaction processing system according to one or more embodiments;

FIG. 7 depicts a block diagram of a high-level network architecture of a computing system environment for operating a processing system according to one or more embodiments;

FIG. 8 depicts a block diagram of a representative software architecture, which may be used in conjunction with various hardware architectures according to one or more embodiments; and

FIG. 9 depicts a block diagram of components of a processing circuit or a processor according to one or more embodiments.

### DETAILED DESCRIPTION

In the following detailed description, only certain exemplary embodiments of the present invention are shown and described, by way of illustration. As those skilled in the art would recognize, the invention may be embodied in many different forms and should 1 not be construed as being limited to the embodiments set forth herein. Like reference numerals designate like elements throughout the specification.

A customer or merchant may conduct business on a financial services platform and receive services from a financial service provider. These services may include, for example, processing payments (e.g., by credit card, buy-now-pay-later, bank account transfers, electronic payment systems, and the like), processing payment disputes, recurring payments (e.g., subscriptions), storing sensitive information (e.g., payment card industry or PCI data), offering loans, local tax compliance, and the like.

There may be risks in providing services to the merchant. Some risks may include the risk that the customer's account may be taken over by a third-party, which may result in fraudulent transactions while the account is controlled by the third-party. Other risks relate to whether the customer may be attempting to defraud the financial services platform, such as accepting a loan without intention of paying the loan back. Some risks are associated with a likelihood that the customer will breach the terms of service (ToS) agreement specifying how a user is allowed to use the financial services platform. Breaches of different terms within the agreement may be associated with different levels or types of risk (e.g., breaching a term of service requiring the customer to display the financial services platform's trademarks correctly on a website may create less risk than a term of service requiring the customer to reside in a jurisdiction that is not under economic sanctions).

These various risks can be reevaluated by obtaining additional information and mitigated through various interventions. For example, the risk associated with account takeover can be reduced by requiring the user to change their password to a stronger password, implementing multi-factor authentication, reducing the scope of rights available to authentication keys (e.g., for accessing application programming interfaces or APIs 1 exposed by the financial services platform), and the like. As another example, the risk of fraud can be reduced by verifying the identity of the user (e.g., through a government-issued identification card and verification of the corresponding person), and/or by verifying documents of incorporation associated with a corporate customer. In some cases, financial risks can be mitigated by withholding payments to the customer or pausing the processing of transactions associated with that customer.

Interventions such as obtaining additional information about a customer and performing mitigating actions can reduce the risk to the business by reducing the risks associated with the customer and/or by improving the accuracy of assessments of the riskiness of specific customers (e.g., the probability that providing services to the customer will result in harm to the business). However, these interventions impose a cost on those customers and may result in degraded customer experience. This may be harmful to relationships with customers who are acting in good faith (e.g., not attempting to defraud the business). For example, requesting a user to use a strong password or to use multi-factor authentication can result in user frustration in creating a compliant password, and may sometimes result in account lockouts and increased customer support interactions. As another example, requesting customers to undergo an identity verification process may require individuals to provide sensitive personal information (e.g., photographs of government identification, personal identification numbers such as social security numbers, credit checks, and the like). As a third example, pausing the processing of transactions or withholding payments can impact a customer's ability to do business.

As such, aspects of embodiments of the present disclosure relate to generating a trusted user metric for a customer, and selecting interventions for gathering information about the customer for estimating different types of risks that the customer may pose to a business providing services to the customer. The computed risks may be used to evaluate or reevaluate the customer's trusted user metric or trusted customer metric (collectively referenced as a trust metric). The computed trust metric may be used by the financial services platform to determine whether to proceed with providing services to the customer, whether to perform an intervention, and/or to determine the risk posture to be taken for the customer.

In some embodiments, the selected interventions are to optimize the gathering of relevant information regarding the customer to improve the accuracy of the estimated risks, in exchange for a relatively low or minimized cost to the customer (e.g., minimizing customer pain or degraded customer experience). In some embodiments, the type of intervention to perform, and the timing of the intervention, are computed based on one or more statistical models trained on historical data relating the effectiveness of various interventions on customers having various customer profiles (e.g., customers having similar characteristics and at various stages of a customer lifecycle, journey, or stage in relation to the business), and the cost to the customers to respond to these interventions. The cost of the intervention may be determined, for example, based on reported satisfaction or net promoter score with the business, and/or other actions (e.g., the customer closing their account in response to the intervention, customer survey results, and/or the like).

As such, aspects of embodiments of the present disclosure provide an automated and statistically tested techniques to generate a single metric of trustworthiness of a customer for consolidating a risk posture towards the customer, and to select and schedule interventions with customers who are classified as being untrustworthy to attempt to improve the trustworthiness of that customer and/or to drive fraudulent customers from using the business.

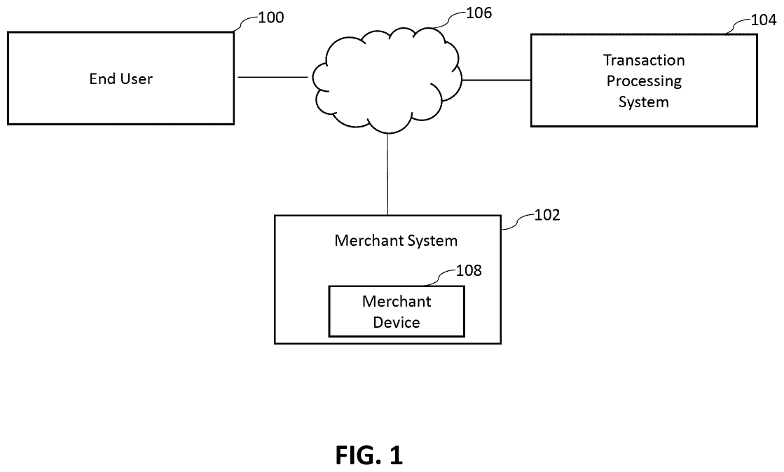

FIG. 1 depicts a computing environment for user classification using machine learning according to one or more embodiments. The computing environment includes an end user device 100, merchant system 102, and a transaction processing system 104 coupled to one another over a data communications network 106. The data communications network 106 may be any wired or wireless local area network (LAN), private wide area network (WAN), and/or the public Internet. The merchant system 102 and the transaction analysis system 104 may be hosted in a single server, or distributed over multiple servers under the control of a single or multiple organizations.

The end user device 100 may be a desktop, laptop, mobile device, smart phone, tablet, and/or any other computing device conventional in the art. A customer, potential customer, fraudster, or other end user (collectively referenced as an end user) desiring to purchase goods or services from a merchant may access the merchant system 102 using the end user device 100.

The merchant system 102 may include one or more servers and/or computing devices. The servers and/or computing devices may include a processor and memory. The memory may include instructions that, when executed by the processor, cause the processor to provide merchant functionality as described herein. For example, the merchant system 102 may provide a web page or application that enables the end user to purchase goods and/or services (collectively referenced as products) sold by the merchant.

In some embodiments, the merchant system 102 includes a point-of-sale (POS) terminal at a merchant location. The POS terminal may include a processor and memory. The memory may store instructions that cause the process to provide checkout functionality for products purchased by an end user from the merchant location. For example, the POS terminal may include software and hardware for accepting credit card 1 information, forwarding the credit card information and associated purchase details to the transaction processing system 104 for approval, and displaying an indication as to whether the credit card has been approved or declined for the requested purchase amount.

In some embodiments, the merchant system 102 communicates with the transaction processing system 104 for processing payment for the products purchased by the end user (either online via the web page or application, or via the POS terminal). The merchant system 102 may collect the transaction information, such as, for example, customer information (e.g., name, shipping address, billing address, and the like), credit card information, purchase amount, and/or the like, and transmit the transaction information to the transaction processing system 104.

In some embodiments, the merchant system 102 includes a merchant device 108 for communicating with the transaction processing system 104 over the data communications network 106. The merchant device 108 may be a desktop, laptop, mobile device, smart phone, tablet, and/or any other computing device conventional in the art. A merchant (also referred to as a customer or user) may access the transaction processing system 104 using the merchant device 108 during, for example, setup or onboarding of the merchant on the transaction processing system. Information may be exchanged between the merchant device 108 and the transaction processing system 104 during the onboarding process to set up a merchant account, profile, and/or other configuration information on the transaction processing system 104.

The merchant device 108 may also be configured to receive interruptions, interventions, and/or other actions (collectively referenced as interventions) from the transaction processing system 104 during or after onboarding. For example, the transaction processing system 104 may generate an intervention to assess (or reassess) a trust metric of the merchant. The intervention may include a request for information from the merchant. The merchant may respond to the request using the merchant device 108.

In some embodiments, the transaction processing system 104 includes a processor and a memory, where the memory includes instructions that cause the processor to provide different types of transaction processing functionality. The transaction processing functionality may include, for example, analyzing transactions for potential fraud, interacting with a bank system for approving or declining the transactions, and interacting with the merchant system 102 to configure a merchant profile, payment page, and/or the like.

In some embodiments, the transaction processing system 104 is configured to evaluate a merchant associated with the merchant system 102, and classify the merchant according to a trust metric. The trust metric may be a composite indicia of trustworthiness of the merchant. For example, the trust metric may take the form of a value for classifying the merchant as trusted, untrusted or unknown.

In some embodiments, the trust metric is computed based on an evaluation of the merchant in one or more risk areas. The evaluation may be based on one or more risk models (e.g., machine learning models) that have been trained to predict one or more different types of risks. In some embodiments, outputs of the risk models are used for determining the trust metric.

In some embodiments, interventions are selected for assessing or reassessing various types of risk and/or for computing or recomputing the trust metric of the merchant. The interventions may be selected to maximize accuracy of a prediction of risk associated with the merchant while minimizing a cost associated with the action. In this regard, the predictive power of the interventions may be evaluated based on the merchant and context surrounding the merchant, in determining which intervention(s) may be appropriate for the current situation. For example, if a merchant is deemed to be “untrusted” because of risk of violating the terms of service, an intervention that requests for the merchant to provide identity verification may not be useful in getting a better assessment of the risk. However, identity verification may be useful for determining risk of an account takeover by the merchant.

Responding to an intervention may incur a cost to the merchant in terms of disruption, inconvenience, or effort (collectively referenced as “pain”). In some embodiments, the selected interventions are scheduled or timed to minimize the pain to the merchant. This may involve, for example, issuing the intervention proactively (e.g., during onboarding) instead of after the merchant has been using the system for a period of time, which may cause more disruption to the merchant's business.

In some embodiments, the trust metric assigned to a merchant is used by the transaction server 104 to determine a risk posture with respect to the merchant. In some embodiments, the type of response by the transaction server 104 to a risk situation involving the merchant may differ based on the merchant's trust metric. For example, if an activity by a merchant that is classified as “untrustworthy” is identified as being potentially fraudulent, the transaction processing system 104 may withhold payments to the merchant, pause the processing of transactions associated with the merchant, invoke an intervention, and/or the like. If, however, the merchant is classified as “trustworthy,” the transaction processing system 104 may invoke additional or higher quality resources (e.g., experienced human reviewers) to confirm that the activity is indeed fraudulent before invoking an intervention or taking action to counter the fraud, which may result in a degraded user experience. In other examples of handling trustworthy merchants differently include: conducting multiple human reviews and only escalating if the reviewers agree that there is a problem; or if a model is used instead of a human, a higher quality and more expensive model (e.g. GPT 4 instead of GPT 3.5) may be used for conducting the review.

Thus, classifying merchants that should be classified as such as early as possible may increase the chance that well-intentioned merchants, including those that are high-value merchants, do not experience bad user experience. On the other hand, interventions or other actions for risk violations for “untrusted” merchants may be warranted. Thus, less resources may be devoted to confirm the risk violations by “untrusted” merchants.

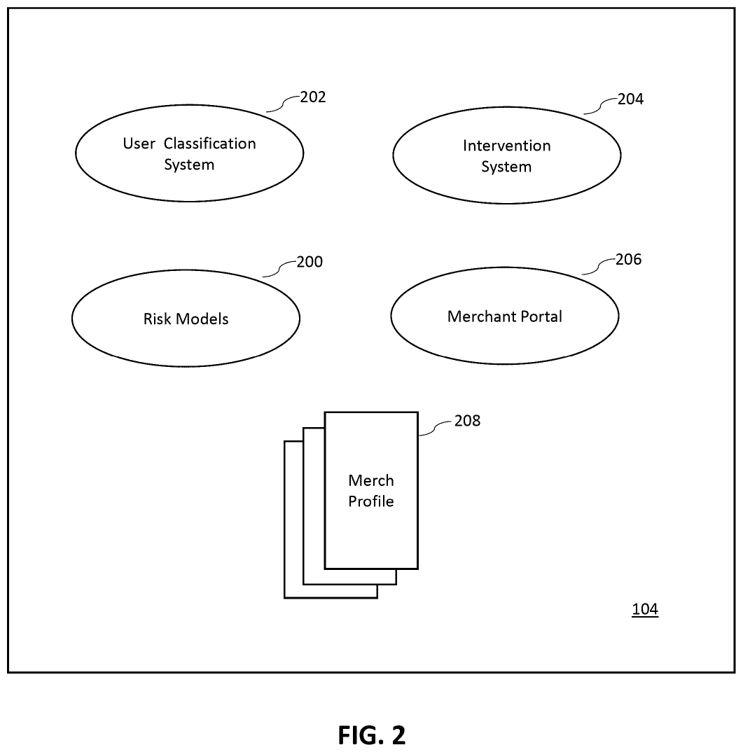

FIG. 2 depicts a block diagram of the transaction processing system 104 according to one or more embodiments. The transaction processing system 104 may include one or more risk models 200, a user classification system 202, an intervention system 204, and a merchant portal 206. Although the risk models 200, user classification system 202, intervention system 204, and merchant portal 206 are depicted in FIG. 2 as separate components, a person of skill in the art should recognize that these components 200-206 may be combined into a single component, or one or more of the components may be further subdivided into additional sub-components as will be appreciated by a person of skill in the art.

In some embodiments, the risk models 200 may include one or more machine learning models that have been trained to predict a risk associated with a merchant in one or more risk areas. For example, the risk models may be trained to predict a risk of fraud, risk of violating a term of service, credit risk, and/or risk of an account takeover. The risk models may be trained using one or more types of machine learning algorithms such as, for example, supervised (e.g., regression algorithms, classification algorithms, neural networks, random forest algorithms, etc.), unsupervised (e.g., K-means clustering algorithm, hierarchical clustering algorithm, etc.), semi-supervised (e.g., a combination of supervised and unsupervised), and/or reinforcement learning (e.g., deep adversarial networks).

In some embodiments, one or more of the risk models 200 is configured to take, as input, information about the merchant and/or actions by the merchant, and provide a score indicative of a likelihood of the associated risk. The score may be a value from 0 to 1, where higher the value, the higher the likelihood of the risk.

In some embodiments, the user classification system 202 generates a trust metric for the merchant based on input data. In some embodiments, the input data is simply the risk scores computed for the merchant by the one or more risk models 200. The user classification system 202 may compare one or more of the scores against corresponding one or more threshold values, and determine whether the one or more scores exceed the corresponding threshold values. The merchant may be classified as “trusted” if none of the scores exceed the corresponding threshold values. The merchant may be classified as “untrusted” or “unknown” if at least one of the scores exceed the corresponding threshold value.

In some embodiments, the user classification system 202 employs a machine learning model to predict the trust metric for the merchant. The machine learning model may be trained using a machine learning algorithm such as, for example, supervised (e.g., regression algorithms, classification algorithms, neural networks, random forest algorithms, etc.), unsupervised (e.g., K-means clustering algorithm, hierarchical clustering algorithm, etc.), semi-supervised (e.g., a combination of supervised and unsupervised), and/or reinforcement learning (e.g., deep adversarial networks).

In some embodiments, the machine learning model is trained based on different input features including, for example, the scores generated by the risk models. Other features used to train the machine learning model may include, for example, merchant profile 208 information, merchant activity, public web presence, past interventions (e.g., whether the account owner has successfully conducted an identity verification), and/or the like. The machine learning model may predict a trust metric for the merchant based on the input features. The trust metric may be an aggregate trust score and/or label indicative of trustworthiness of the merchant. For example, if the predicted aggregate trust score is above a set threshold, the merchant may be labeled as “trustworthy.” If the predicted aggregate trust score is below the set threshold, the merchant may be labeled as “untrustworthy.”

In some embodiments, a merchant whose aggregate trust score indicates that the merchant is “untrustworthy” may instead be labeled as “unknown” if the untrustworthiness is due to insufficient information about the merchant. A determination of insufficient information about the merchant may depend, for example, on merchant features (e.g., merchant type, merchant size, merchant tenure, stage of the customer lifecycle/journey, etc.), and/or transaction features (e.g., total number of transactions, total payment volume, total revenue, etc.). A minimum threshold may be identified for the various features, and a determination may be made as to whether the minimum threshold values have been met for one or more of the features. If one or more of the minimum threshold values have not been met, the merchant may be classified as “unknown.”

In some embodiments, the intervention system 204 is configured to identify one or more interventions, and scheduling of the interventions, for gathering information from or about the merchant. In some instances, the intervention may be a prompt to the merchant to take action or to provide information to address a possible violation. For example, if the merchant's website does not appear to provide an acceptable description of the goods or services offered by the merchant, the intervention may be for the merchant to update the website with the requisite information. In another example, the intervention may be a request for the merchant to provide company incorporation documents if there is a risk that the merchant may be incorporated in a country where the transaction processing system is unable to conduct business. In yet another example, the intervention may be identity verification (e.g., request for a government provided identification document along with a showing of the user's face) to ensure that the user is an authorized user associated with the merchant.

In some embodiments, the intervention system 204 includes a machine learning model that is trained to select an intervention using one or more types of machine learning algorithms such as, for example, supervised (e.g., regression algorithms, classification algorithms, neural networks, random forest algorithms, etc.), unsupervised (e.g., K-means clustering algorithm, hierarchical clustering algorithm, etc.), semi-supervised (e.g., a combination of supervised and unsupervised), and/or reinforcement learning (e.g., deep adversarial networks). Hereinafter the term intervention may be used to refer to both a type of intervention and a timing or scheduling of the intervention.

In some embodiments, the intervention that is selected by the machine learning model is one that is predicted to maximize accuracy of a predicted trust metric or risk score, while minimizing a cost associated with the intervention. The selection of an intervention in this manner may allow the gathering of reliable information about the merchant to allow the merchant to be eventually classified as a “high information” merchant, and/or shorten a time (referred to as a “get to know you” curve) that it takes for the merchant that should be considered trusted, to be classified as such.

In some embodiments, the cost of the intervention is indicative of the pain that the merchant may experience in responding to the intervention. In some embodiments, different costs are associated with the intervention depending on when the intervention is made. The interventions may be made at different stages of a customer journey or lifecycle on the transaction processing system 104. The different stages of the customer journey may be marked, for example, by different milestones that may be associated with, for example, a length of tenure on the transaction processing system 104. Some examples of milestones of the customer journey include: application submission (can't process payments until approved); 2) first payment processed; and 3) three payments processed (to make the BIN sponsor aware of the merchant.) For example, the cost of an intervention for a new merchant at the beginning stage of the journey may be higher than the cost of the intervention for a merchant who has been using the transaction processing system 104 for a length of time. That is, the longer the merchant uses the system, the more transactions are expected to be handled by the merchant, and hence, the bigger the disruption to the merchant's business in responding to the intervention. For example, the pain from an intervention may scale as a function of the user's payment volume. At Stage 2, the merchant may still be just running a test charge or two. The more charges that get processed, the greater the likelihood that the system is running in production, and the user pain from an intervention may increase significantly.

Other factors that may increase or decrease cost of an intervention may relate to different seasons, times of the day, whether the merchant has an account manager to help work with the merchant to resolve the issue, and/or the like.

In an embodiment where the intervention system 204 uses supervised learning, the machine learning model for recommending an intervention may be trained with a set of training data that is labeled with a score indicative of desirability of the intervention. The score may be proportional to the predictive power of the information to be gained from the intervention, and inversely proportional to the cost to the merchant. The machine learning model may be trained to generate an intervention that maximizes the score based on the input features associated the merchant.

In some embodiments, historical data of interventions provided to the merchants on the transaction processing system 104, and results achieved from the interventions, may be used to generate the training data. In some embodiments, the training data includes risk scores of the various risk models for a merchant, the merchant's profile 208, merchant activity, type of intervention, timing of the intervention, amount of information received from the intervention, cost to the merchant, and/or the like.

In an embodiment where the intervention system 204 uses reinforcement learning for recommending an intervention, the machine learning model may use experience gained from the issuance of past interventions to select an intervention for a merchant based on a current state. The current state may include, for example, risk scores for the merchant from the various risk models, the merchant's profile 208, merchant activity, information about available interventions (including timing of the interventions), and/or the like.

The intervention system 204 may take the action of the selected intervention at a scheduled time (e.g., at an identified milestone of the merchant's journey), and receive information associated with the merchant in response. After the action is performed, the intervention system 204 may receive a reward or reinforcement (whether positive or negative). The reward may be, for example, a trusted merchant being classified as trusted, a shortened “get to know you” curve, classification of the merchant as “high information” merchant, increased accuracy of the risk scores provided by the risk models 200, and/or the like. In some embodiments, a human reviewer may review the information requested by the intervention, and provide feedback as to the reward or relevancy of the information.

In some embodiments, the reinforcement is provided by the merchant. For example, the merchant may provide feedback indicative of the amount of pain generated by the intervention. The feedback may include a reported satisfaction by the merchant, a net promoter score by the merchant, action by the merchant (e.g., merchant closing its account), responses to survey questions, social media posts, escalations to executives of the transaction processing system, and/or the like. In some embodiments, the intervention system 204 stores the received reward or reinforcement with the current state to learn from the experience and adjust selection of future interventions based on the experience.

In some embodiments, the transaction processing system 104 stores a merchant profile 208 for each merchant using the transactions processing system. The merchant profile 208 may be identified by a merchant ID assigned to the merchant. The merchant profile 208 may include information about the merchant including, without limitation, merchant size, merchant tenure, merchant product or service number of transactions, total payment value, total revenue, and/or the like.

In some embodiments, the transaction processing system 104 includes a merchant portal 206 that may include a graphical user interface (GUI) or application programming interface (API). The merchant portal 206 may be accessed by the merchant system 102 to exchange data with the transaction processing system 104. For example, interventions may be provided to the merchant system 102 via the merchant portal 206. The merchants may respond to the interventions by submitting the requested information via the merchant portal 206.

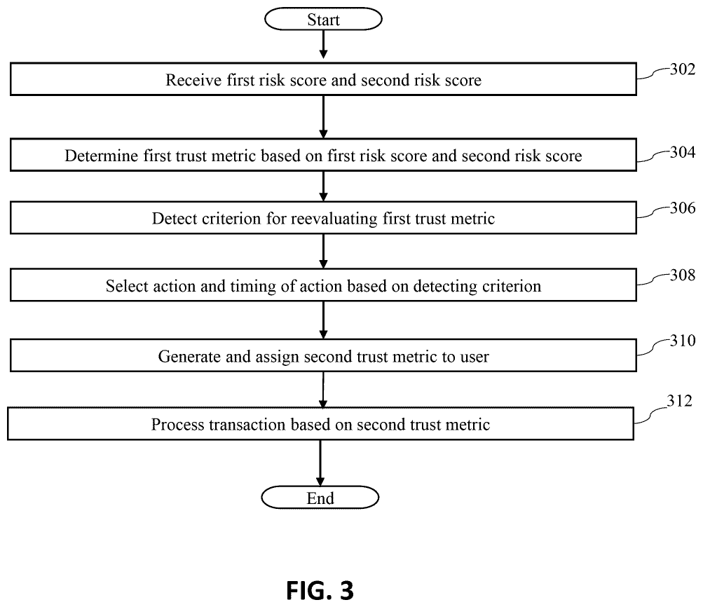

FIG. 3 depicts a flow diagram of a process for user classification and transaction processing according to one or more embodiments. The process begins, and in act 302, the user classification system 202 receives first and second scores for respectively first and second characteristics associated with the user. An initial set of scores may be generated, for example, during onboarding of the user on the transaction processing system 104. The initial set of scores may be recalculated upon detecting certain triggers, such as, for example, a change of payout method, change of merchant information (e.g., password, email address, mailing address, etc.), amount and timing of transactions processed by the merchant, charge amounts processed by the merchant, and/or the like.

The scores may be provided by the risk models 200 based on different types of risk predicted for the user. One or more machine learning models that are trained to predict risk in one or more risk areas may be invoked for predicting the risk scores for the user. In this regard, different scores may be provided to predict risk of fraud by the merchant, risk of violation of the terms of service, risk of merchant bad credit, account takeover risk, and/or the like.

In act 304, the user classification system 202 evaluates the risk scores to determine a first metric (e.g., a trust metric) for the user. The trust metric may identify the user as trusted, untrusted, or unknown. For example, the user may be classified as “trusted” if none of the scores exceed the corresponding threshold values, and as “untrusted” or “unknown” if at least one of the scores exceed the corresponding threshold value.

In some embodiments, the user classification system 202 employs a machine learning model to predict the trust metric for the merchant. In this regard, the machine learning model receives, as input, the risk scores provided by the risk models, merchant profile 208 information, merchant activity, and/or the like, and generates a value for classifying the user as trusted, untrusted, or unknown.

In act 306, the user classification system 202 receives a criterion for reevaluating the first trust metric. The criterion may be, for example, detecting that one or more of the risk scores generated by the risk models exceed a threshold score.

In act 308, the intervention system 204 selects an action (e.g., intervention), and timing of the action, based on detecting the criterion. The action may be for obtaining information associated with the user. The selected action may be identified by an action type, action ID, and/or the like. For example, the action ID may identify a canned prompt that requests a certain type of information from the user.

In some embodiments, the action is for maximizing accuracy of a prediction of a second metric (e.g., trust metric) for the user, and minimizing a cost associated with the action. For example, in the event that reevaluation is triggered due to a prediction of fraud by the merchant, the action may ask the merchant to verify his identity (e.g., request that the merchant provide an identification document along with a showing of the user's face), to ensure that the user is an authorized user associated with the merchant. In some embodiments, the recommended action (and timing of the action) is provided to a system administrator for approval prior to issuing the action.

The merchant may respond to the action by providing the requested information. In act 310, the user classification system 202 computes a second trust metric for the user based on the information received from the user, and assigns the second trust metric to the user. For example, the second trust metric may be stored in the user's merchant profile 208.

In act 312, a transaction is processed based on the second trust metric. For example, if the transaction is flagged as posing a risk, the manner in which the transaction is processed may differ based on whether the user is trusted or not. If the user is trusted, the transaction processing system 204 may invoke resources (e.g., an experienced human reviewer) to review the transaction to confirm that the transaction indeed poses a risk. Doing so may help prevent unnecessary remediation actions to counter the risk that may result in degraded customer experience. If the user is untrusted or unknown, the transaction processing system 204 may be more liberal in taking the remediation action, including, for example, withholding payments to the merchant, pausing the processing of the transaction, issuing an intervention, and/or the like.

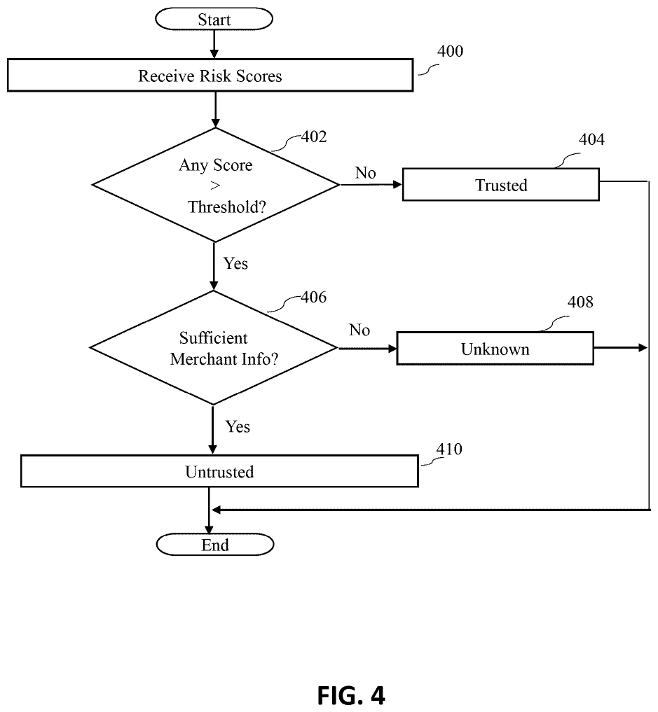

FIG. 4 depicts a flow diagram of a process for classifying a user according to a trust metric according to one or more embodiments. The process starts, and in act 400, the user classification system receives risk scores from the risk models 200. The risk scores may predict a bad action by the merchant including, for example, fraud, violation of the terms of service, bad credit, account takeover, and/or the like.

In act 402, a determination is made as to whether any if the scores exceed a maximum threshold value. If the answer is NO, the merchant is classified as “trusted.” The trusted classification may be stored in the merchant's profile 208 associated with the merchant.

Referring again to act 402, if one or more of the scores exceed the maximum threshold value, the merchant cannot be classified as “trusted.” In some embodiments, the inability to classify the merchant as trusted is because of insufficient information associated with the merchant. For example, certain risk scores may require a minimum number of transactions, tenure time, or the like, before a risk score may be computed. In this regard, in act 406, a determination is made as to whether sufficient information about the merchant exists. If the answer is NO, the merchant is classified as “unknown” in act 408.

If the answer is YES, the merchant is classified as “untrusted” in act 410. Both the “unknown” and “untrusted” classifications may be stored in the merchant profile 208 associated with the merchant.

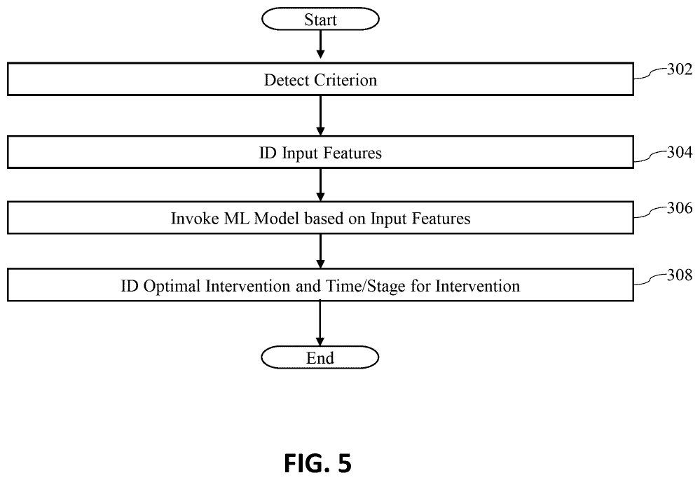

FIG. 5 depicts a flow diagram of a process for selecting an intervention according to one or more embodiments. The process starts, and in act 500, the intervention system 204 detects a criterion for issuing an intervention. The criterion may be, for example, detecting that one or more of the risk scores generated by the risk models 200 exceed a threshold score, and/or the like. The criterion may also include detecting missing merchant information that may be needed now or may be believed to be needed in the future (e.g. for compliance purposes), or if there is reason to believe that some data about the merchant is old/stale.

In act 502, the intervention system 204 identifies input features to be considered for selecting the intervention. The input features may be generated based on information about the merchant in the merchant profile 208, risk scores generated by the risk models 200, merchant activity information, and/or the like.

In act 504, the intervention system 204 invokes the machine learning model based on the input features.

In act 506, the machine learning model identifies an intervention (e.g., type and/or substance of the intervention) and a time or stage (e.g., a stage in the merchant journey) for issuing the intervention, based on the input features. In some embodiments, the intervention is for gathering information from the merchant that helps maximize accuracy of a predicted trust metric for the merchant while minimizing pain to the merchant to respond to the intervention. For example, the machine learning model may select an intervention that aims to gather information for the merchant in an area where there is insufficient information, gather information related to a risk area where the risk score exceeds a maximum threshold, and/or the like. Obtaining such information may allow the user classification system 202 to be more accurate in the generating of the risk scores, which in turn may allow a more accurate classification of the user as “trusted,” “untrusted,” or “unknown.” The information may also help shorten the merchant's “get to know you” curve, expedite the classification of the merchant as a “high information” merchant, and/or maximize other types of rewards while minimizing cost.

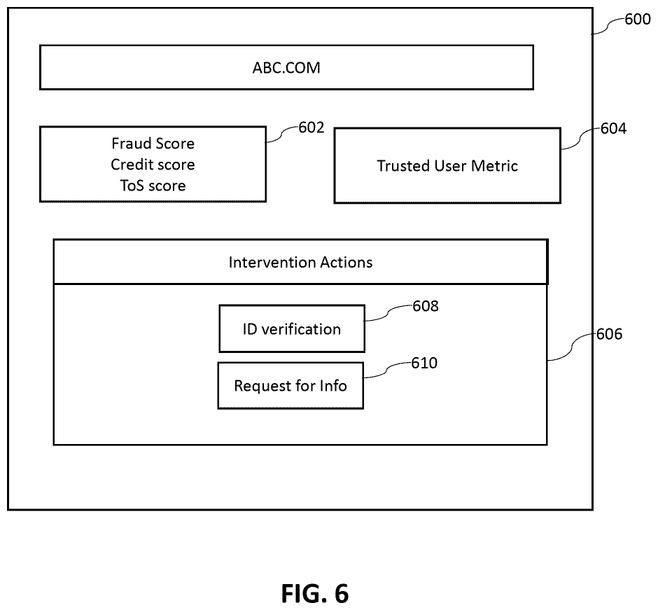

FIG. 6 depicts a graphical user interface (GUI) 600 provided by the transaction processing system 104 according to one or more embodiments. The GUI 600 may be accessed by a system administrator for viewing information about the merchants enrolled in the transaction processing system 104, and taking actions with respect to the merchants. The system administrator may view the merchant information from time to time, or based upon a trigger. The trigger may be, for example, change of a trust metric for a merchant, a risk score falling below a threshold value, intervention actions being recommended for the merchant, and/or the like.

In some embodiments, the GUI 600 includes a risk score window 602 for displaying one or more risk scores for the merchant. The GUI 604 further includes a trusted user metric window 604 for displaying a trust metric generated for the merchant by the user classification system 202. For example, the trusted user metric window may identify the merchant at “trusted,” “untrusted,” or “unknown.”

In some embodiments, the GUI 606 includes an intervention window 606 for displaying one or more intervention actions 608, 610. In some embodiments, the displayed intervention actions 608, 610 are actions recommended by the intervention system 204. The system administrator may select a displayed invention action 608, 610 to execute the action. For example, if the intervention is for identity verification, the system administrator may select the “ID verification” option 610 to review the text (e.g., default text) of a prompt that provides information to the merchant as to the information that is required, and how to provide the information.

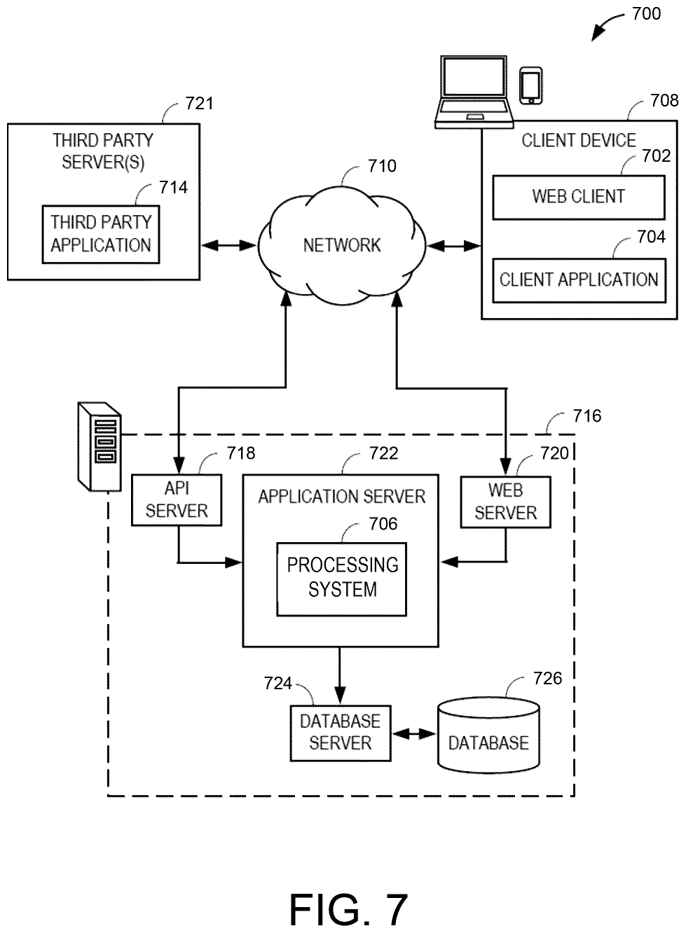

With reference to FIG. 7, an example embodiment of a high-level SaaS network architecture 700 is shown. A networked system 716 provides server-side functionality via a network 710 (e.g., the Internet or a WAN) to a client device 708 (similar to the merchant device 108 of FIG. 1). A web client 702 and a programmatic client, in the example form of a client application 704 (e.g., client software for communicating with the transaction processing system 104 of FIG. 2), are hosted and execute on the client device 708. The networked system 716 includes one or more servers 722 (e.g., servers hosting services exposing remote procedure call APIs), which hosts a processing system 706 (such as the transaction processing system 104 described above according to various embodiments of the present disclosure) that provides a number of functions and services via a service oriented architecture (SOA) and that exposes services to the client application 704 that accesses the networked system 716 where the services may correspond to particular workflows. The client application 704 also provides a number of interfaces described herein, which can present an output in accordance with the methods described herein to a user of the client device 708.

The client device 708 enables a user to access and interact with the networked system 716 and, ultimately, the processing system 706. For instance, the user provides input (e.g., touch screen input or alphanumeric input) to the client device 708, and the input is communicated to the networked system 716 via the network 710. In this instance, the networked system 716, in response to receiving the input from the user, communicates information back to the client device 708 via the network 710 to be presented to the user.

An API server 718 and a web server 720 are coupled, and provide programmatic and web interfaces respectively, to the servers 722. For example, the API server 718 and the web server 720 may produce messages (e.g., RPC calls) in response to inputs received via the network, where the messages are supplied as input messages to workflows orchestrated by the processing system 706. The API server 718 and the web server 720 may also receive return values (return messages) from the processing system 706 and return results to calling parties (e.g., web clients 702 and client applications 704 running on client devices 708 and third-party applications 714) via the network 710. The servers 722 host the processing system 706, which includes components or applications in accordance with embodiments of the present disclosure as described above. The servers 722 are, in turn, shown to be coupled to one or more database servers 724 that facilitate access to information storage repositories (e.g., databases 726). In an example embodiment, the databases 726 includes storage devices that store information accessed and generated by the processing system 706, such as merchant profile 208 information of FIG. 2 and other databases such as databases storing information associated with transactions processed by a business.

Additionally, a third-party application 714, executing on one or more third-party servers 721, is shown as having programmatic access to the networked system 716 via the programmatic interface provided by the API server 718. For example, the third-party application 714, using information retrieved from the networked system 716, may support one or more features or functions on a website hosted by a third-party.

Turning now specifically to the applications hosted by the client device 708, the web client 702 may access the various systems (e.g., the processing system 706) via the web interface supported by the web server 720. Similarly, the client application 704 (e.g., an “app” such as a payment processor app) may access the various services and functions provided by the processing system 706 via the programmatic interface provided by the API server 718. The client application 704 may be, for example, an “app” executing on the client device 708, such as an iOS or Android OS application to enable a user to access and input data on the networked system 716 in an offline manner and to perform batch-mode communications between the client application 704 and the networked system 716.

Further, while the network architecture 700 shown in FIG. 7 employs a client-server architecture, the present disclosure is not limited to such an architecture, and could equally well find application in a distributed, or peer-to-peer, architecture system, for example.

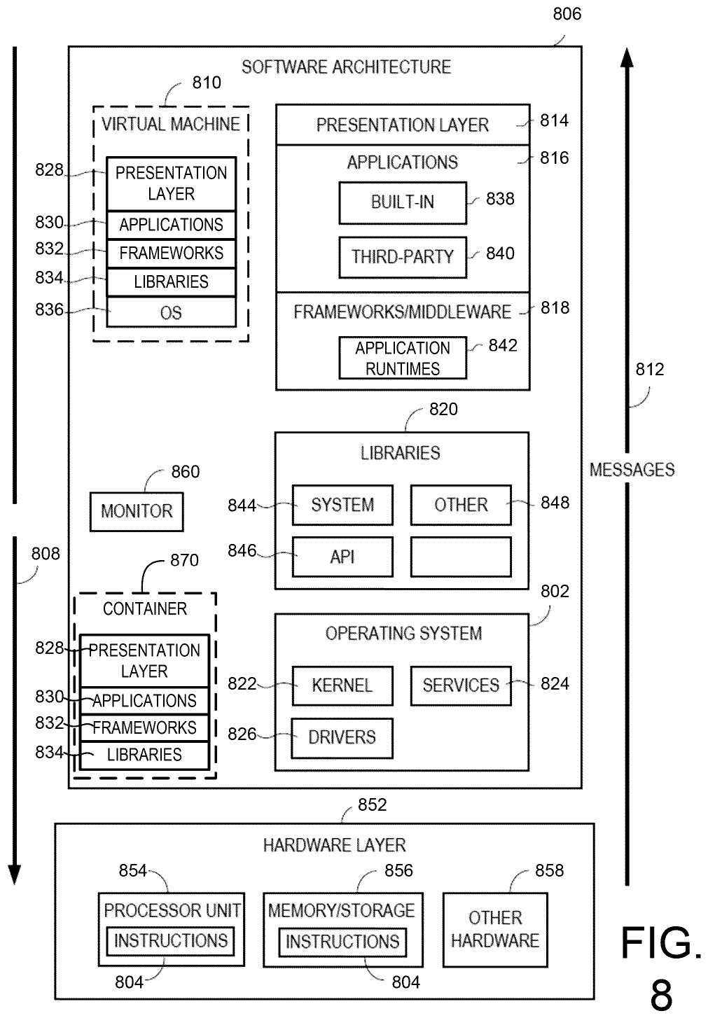

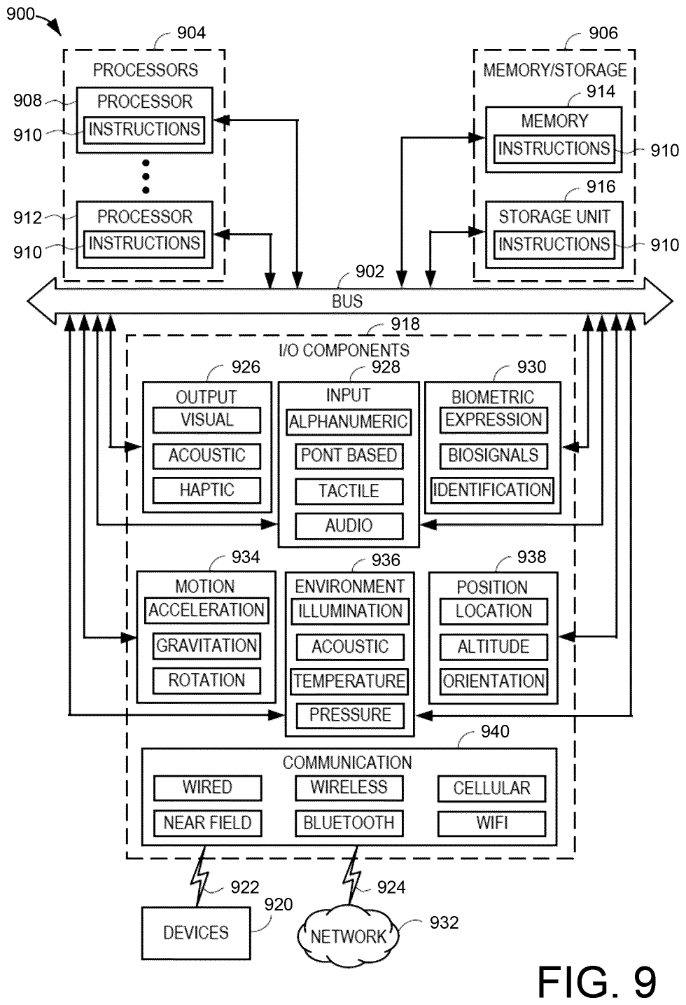

FIG. 8 is a block diagram illustrating an example software architecture 806, which may be used in conjunction with various hardware architectures herein described. FIG. 8 is a non-limiting example of a software architecture 806, and it will be appreciated that many other architectures may be implemented to facilitate the functionality described herein. The software architecture 806 may execute on hardware such as a machine 900 of FIG. 9 that includes, among other things, processors 904, memory/storage 906, and input/output (I/O) components 918. A representative hardware layer 852 is illustrated and can represent, for example, the machine 900 of FIG. 9. The representative hardware layer 852 includes a processor 854 having associated executable instructions 804. The executable instructions 804 represent the executable instructions of the software architecture 806, including implementation of the methods, components, and so forth described herein. The hardware layer 852 also includes non-transitory memory and/or storage modules as memory/storage 856, which also have the executable instructions 804. The hardware layer 852 may also include other hardware 858.

In the example architecture of FIG. 8, the software architecture 806 may be conceptualized as a stack of layers where each layer provides particular functionality. For example, the software architecture 806 may include layers such as an operating system 802, libraries 820, frameworks/middleware 818, applications 816 (such as the services of the transaction processing system 104), and a presentation layer 814. Operationally, the applications 816 and/or other components within the layers may invoke API calls 808 through the software stack and receive a response as messages 812 in response to the API calls 808. The layers illustrated are representative in nature, and not all software architectures have all layers. For example, some mobile or special-purpose operating systems may not provide a frameworks/middleware 818, while others may provide such a layer. Other software architectures may include additional or different layers.

The operating system 802 may manage hardware resources and provide common services. The operating system 802 may include, for example, a kernel 822, services 824, and drivers 826. The kernel 822 may act as an abstraction layer between the hardware and the other software layers. For example, the kernel 822 may be responsible for memory management, processor management (e.g., scheduling), component management, networking, security settings, and so on. The services 824 may provide other common services for the other software layers. The drivers 826 are responsible for controlling or interfacing with the underlying hardware. For instance, the drivers 826 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 820 provide a common infrastructure that is used by the applications 816 and/or other components and/or layers. The libraries 820 provide functionality that allows other software components to perform tasks in an easier fashion than by interfacing directly with the underlying operating system 802 functionality (e.g., kernel 822, services 824, and/or drivers 826). The libraries 820 may include system libraries 844 (e.g., C standard library) that may provide functions such as memory allocation functions, string manipulation functions, mathematical functions, and the like. In addition, the libraries 820 may include API libraries 846 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), and the like. The libraries 820 may also include a wide variety of other libraries 848 to provide many other APIs to the applications 816 and other software components/modules.

The frameworks/middleware 818 provide a higher-level common infrastructure that may be used by the applications 816 and/or other software components/modules. For example, the frameworks/middleware 818 may provide high-level resource management functions, web application frameworks, application runtimes 842 (e.g., a Java virtual machine or JVM), and so forth. The frameworks/middleware 818 may provide a broad spectrum of other APIs that may be utilized by the applications 816 and/or other software components/modules, some of which may be specific to a particular operating system or platform.

The applications 816 include built-in applications 838 and/or third-party applications 840. The applications 816 may use built-in operating system functions (e.g., kernel 822, services 824, and/or drivers 826), libraries 820, and frameworks/middleware 818 to create user interfaces to interact with users of the system. Alternatively, or additionally, in some systems, interactions with a user may occur through a presentation layer, such as the presentation layer 814. In these systems, the application/component “logic” can be separated from the aspects of the application/component that interact with a user.

Some software architectures use virtual machines. In the example of FIG. 8, this is illustrated by a virtual machine 810. The virtual machine 810 creates a software environment where applications/components can execute as if they were executing on a hardware machine (such as the machine 900 of FIG. 9, for example). The virtual machine 810 is hosted by a host operating system (e.g., the operating system 802 in FIG. 8) and typically, although not always, has a virtual machine monitor 860 (or hypervisor), which manages the operation of the virtual machine 810 as well as the interface with the host operating system (e.g., the operating system 802). A software architecture executes within the virtual machine 810 such as an operating system (OS) 836, libraries 834, frameworks 832, applications 830, and/or a presentation layer 828. These layers of software architecture executing within the virtual machine 810 can be the same as corresponding layers previously described or may be different.

Some software architectures use containers 870 or containerization to isolate applications. The phrase “container image” refers to a software package (e.g., a static image) that includes configuration information for deploying an application, along with dependencies such as software components, frameworks, or libraries that are required for deploying and executing the application. As discussed herein, the term “container” refers to an instance of a container image, and an application executes within an execution environment provided by the container. Further, multiple instances of an application can be deployed from the same container image (e.g., where each application instance executes within its own container). Additionally, as referred to herein, the term “pod” refers to a set of containers that accesses shared resources (e.g., network, storage), and one or more pods can be executed by a given computing node. A container 870 is similar to a virtual machine in that it includes a software architecture including libraries 834, frameworks 832, applications 830, and/or a presentation layer 828, but omits an operating system and, instead, communicates with the underlying host operating system 802.

FIG. 9 is a block diagram illustrating components of a machine 900, according to some example embodiments, able to read instructions from a non-transitory machine-readable medium (e.g., a computer-readable storage medium) and perform any one or more of the methodologies discussed herein. Specifically, FIG. 9 shows a diagrammatic representation of the machine 900 in the example form of a computer system, within which instructions 910 (e.g., software, a program, an application, an applet, an app, or other executable code) for causing the machine 900 to perform any one or more of the methodologies discussed herein may be executed. As such, the instructions 910 may be used to implement modules or components described herein. The instructions 910 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may include, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 910, sequentially or in parallel or concurrently, that specify actions to be taken by the machine 900. Further, while only a single machine 900 is illustrated, the term “machine” or “processing circuit” shall also be taken to include a collection of machines that individually or jointly execute the instructions 910 to perform any one or more of the methodologies discussed herein.

The machine 900 may include processors 904 (including processors 908 and 912), memory/storage 906, and I/O components 918, which may be configured to communicate with each other such as via a bus 902. The memory/storage 906 may include a memory 914, such as a main memory, or other memory storage, and a storage unit 916, both accessible to the processors 904 such as via the bus 902. The storage unit 916 and memory 914 store the instructions 910 embodying any one or more of the methodologies or functions described herein. The instructions 910 may also reside, completely or partially, within the memory 914, within the storage unit 916, within at least one of the processors 904 (e.g., within the processor's cache memory), or any suitable combination thereof, during execution thereof by the machine 900. Accordingly, the memory 914, the storage unit 916, and the memory of the processors 904 are examples of machine-readable media.

The I/O components 918 may include a wide variety of components to receive input, provide output, produce output, transmit information, exchange information, capture measurements, and so on. The specific I/O components 918 that are included in a particular machine will depend on the type of machine. For example, portable machines such as mobile phones may include a touch input device or other such input mechanisms, while a headless server machine will likely not include such a touch input device. It will be appreciated that the I/O components 918 may include many other components that are not shown in FIG. 9. The I/O components 918 are grouped according to functionality merely for simplifying the following discussion, and the grouping is in no way limiting. In various example embodiments, the I/O components 918 may include output components 926 and input components 928. The output components 926 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 928 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 918 may include biometric components 930, motion components 934, environment components 936, or position components 938, among a wide array of other components. For example, the biometric components 930 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 934 may include acceleration sensor components (e.g., accelerometer), gravitation sensor components, rotation sensor components (e.g., gyroscope), and so forth. The environment components 936 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 918 may include communication components 940 operable to couple the machine 900 to a network 932 or devices 920 via a coupling 924 and a coupling 922, respectively. For example, the communication components 940 may include a network interface component or other suitable device to interface with the network 932. In further examples, the communication components 940 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 920 may be another machine or any of a wide variety of peripheral devices (e.g., a peripheral device coupled via a USB).

Moreover, the communication components 940 may detect identifiers or include components operable to detect identifiers. For example, the communication components 940 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 940, such as location via Internet Protocol (IP) geo-location, location via Wi-Fi® signal triangulation, location via detecting an NFC beacon signal that may indicate a particular location, and so forth.

It should be understood that the sequence of steps of the processes described herein in regard to various methods and with respect various flowcharts is not fixed, but can be modified, changed in order, performed differently, performed sequentially, concurrently, or simultaneously, or altered into any desired order consistent with dependencies between steps of the processes, as recognized by a person of skill in the art. Further, as used herein and in the claims, the phrase “at least one of element A, element B, or element C” is intended to convey any of: element A, element B, element C, elements A and B, elements A and C, elements B and C, and elements A, B, and C.

The systems and methods for computing a trusted user metric and issuing interventions may contain one or more combination of features set forth in the below statements.

Statement 1. A method includes receiving a first score for a first characteristic associated with a user and a second score for a second characteristic associated with the user. The first and second scores may be evaluated for determining a first metric for the user. A criterion may be detected for reevaluating the first metric. Based on detecting the criterion, a first action and a timing of the first action may be selected for obtaining information associated with the user. The first action and timing of the first action may be configured to maximize accuracy of a prediction of a second metric and minimize a cost associated with the first action. The second metric may be generated based on the information obtained via the first action. A second action may be performed based on the second metric.

Statement 2. The method of Statement 1, wherein the first characteristic or the second characteristic is based on one or more conditions associated with risk.

Statement 3. The method of Statement 1, wherein the first score is generated by a first machine learning model and the second score is generated by a second machine learning model, wherein the first machine learning model and the second machine learning model are different models.

Statement 4. The method of Statement 1, wherein the first metric or the second metric is indicative of a characteristic associated with a profile of the user.

Statement 5. The method of Statement 1, wherein the criterion is detected in response to the first score or the second score being greater than a threshold score.

Statement 6. The method of Statement 1, wherein the criterion is detected in response to the first metric being different from a target metric.

Statement 7. The method of Statement 1, wherein the selecting of the first action and the timing of the first action includes: identifying one or more features of the user; providing the one or more features to a machine learning model; and receiving from the machine learning model identification of the first action and the timing of the first action.

Statement 8. The method of Statement 1, wherein the first action includes one of an identity verification request to the user, request for information about services provided by the user, or request to provide information regarding a profile of the user.

Statement 9. A system comprising: a processor; and a memory, wherein the memory stores instructions that, when executed by the processor, cause the processor to: identify a first score for a first attribute associated with a user and a second score for a second attribute associated with the user; determine a first metric for the user based on the first score and the second score; detect a criterion for reevaluating the first metric; based on detecting the criterion, select an first action and timing of the first action for obtaining information associated with the user, wherein the selected first action and timing of the first action are configured to maximize accuracy of a prediction of a second metric for the user and minimize a cost associated with the first action; determine a second metric for the user based on the information obtained via the first action; and perform a second action associated with the user based on the second metric.

Statement 10. The system of Statement 9, wherein the first characteristic or the second characteristic is based on one or more conditions associated with risk.

Statement 11. The system of Statement 9, wherein the first score is generated by a first machine learning model and the second score is generated by a second machine learning model, wherein the first machine learning model and the second machine learning model are different models.

Statement 12. The system of Statement 9, wherein the first metric or the second metric is indicative of a characteristic associated with a profile of the user.

Statement 13. The system of Statement 9, wherein the instructions cause the processor to detect the criterion in response to the first score or the second score being greater than a threshold score.

Statement 14. The system of Statement 9, wherein the instructions cause the processor to detect the criterion in response to the first metric being different from a target metric.

Statement 15. The system of Statement 9, wherein the instructions that cause the processor to select the first action and the timing of the first action include instructions that cause the processor to: identify one or more features of the user; provide the one or more features to a machine learning model; and receive from the machine learning model identification of the first action and the timing of the first action.

Statement 16. The system of Statement 9, wherein the first action includes one of an identity verification request to the user, request for information about services provided by the user, or request to provide information regarding a profile of the user.

Statement 17. A non-transitory computer readable storage media having instructions stored thereupon which, when executed by a system having at least a processor and a memory therein, cause the processor to perform operations for executing data access requests in a distributed storage system, comprising: receiving a first score for a first characteristic associated with a user and a second score for a second characteristic associated with the user; evaluating the first score and the second score for determining a first metric for the user; detecting a criterion for reevaluating the first metric; based on detecting the criterion, selecting a first action and a timing of the first action for obtaining information associated with the user, wherein the selected first action and timing of the first action are configured to maximize accuracy of a prediction of a second metric for the user and minimize a cost associated with the first action; generating the second metric based on the information obtained via the first action; and performing a second action associated with the user based on the second metric.

Statement 18. The non-transitory computer readable storage media of Statement 17, wherein the first score is generated by a first machine learning model and the second score is generated by a second machine learning model, wherein the first machine learning model and the second machine learning model are different models.

Statement 19. The non-transitory computer readable storage media of Statement 17, wherein the criterion is detected in response to the first score or the second score being greater than a threshold score, or in response to the first metric being different from a target metric.

Statement 20. The non-transitory computer readable storage media of Statement 17, wherein the selecting of the first action and the timing of the first action includes: identifying one or more features of the user; providing the one or more features to a machine learning model; and receiving from the machine learning model identification of the first action and the timing of the first action.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method comprising:
receiving a first score for a first characteristic associated with a user and a second score for a second characteristic associated with the user;
evaluating the first score and the second score to determine a first metric for the user;
detecting a criterion for reevaluating the first metric;
based on detecting the criterion, selecting a first action and a timing of the first action to obtain information associated with the user, wherein the selected first action and timing of the first action are configured to maximize accuracy of a prediction of a second metric for the user and minimize a cost associated with the first action;
generating the second metric based on the information obtained via the first action; and
performing a second action associated with the user based on the second metric.

2. The method of claim 1, wherein the first characteristic or the second characteristic is based on one or more conditions associated with risk.

3. The method of claim 1, wherein the first score is generated by a first machine learning model and the second score is generated by a second machine learning model, wherein the first machine learning model and the second machine learning model are different models.

4. The method of claim 1, wherein the first metric or the second metric is indicative of a characteristic associated with a profile of the user.

5. The method of claim 1, wherein the criterion is detected in response to the first score or the second score being greater than a threshold score.

6. The method of claim 1, wherein the criterion is detected in response to the first metric being different from a target metric.

7. The method of claim 1, wherein the selecting of the first action and the timing of the first action includes:
identifying one or more features of the user;
providing the one or more features to a machine learning model; and
receiving from the machine learning model identification of the first action and the timing of the first action.

8. The method of claim 1, wherein the first action includes one of an identity verification request to the user, request for information about services provided by the user, or request to provide information regarding a profile of the user.

9. A system comprising:
a processor; and
a memory, wherein the memory stores instructions that, when executed by the processor, cause the processor to:
identify a first score for a first attribute associated with a user and a second score for a second attribute associated with the user;
determine a first metric for the user based on the first score and the second score;
detect a criterion for reevaluating the first metric;
based on detecting the criterion, select an first action and timing of the first action for obtaining information associated with the user, wherein the selected first action and timing of the first action are configured to maximize accuracy of a prediction of a second metric for the user and minimize a cost associated with the first action;
determine a second metric for the user based on the information obtained via the first action; and
perform a second action associated with the user based on the second metric.

10. The system of claim 9, wherein the first characteristic or the second characteristic is based on one or more conditions associated with risk.

11. The system of claim 9, wherein the first score is generated by a first machine learning model and the second score is generated by a second machine learning model, wherein the first machine learning model and the second machine learning model are different models.

12. The system of claim 9, wherein the first metric or the second metric is indicative of a characteristic associated with a profile of the user.

13. The system of claim 9, wherein the instructions cause the processor to detect the criterion in response to the first score or the second score being greater than a threshold score.

14. The system of claim 9, wherein the instructions cause the processor to detect the criterion in response to the first metric being different from a target metric.

15. The system of claim 9, wherein the instructions that cause the processor to select the first action and the timing of the first action include instructions that cause the processor to:
identify one or more features of the user;
provide the one or more features to a machine learning model; and
receive from the machine learning model identification of the first action and the timing of the first action.

16. The system of claim 9, wherein the first action includes one of an identity verification request to the user, request for information about services provided by the user, or request to provide information regarding a profile of the user.

17. A non-transitory computer readable storage media having instructions stored thereupon which, when executed by a system having at least a processor and a memory therein, cause the processor to perform operations for executing data access requests in a distributed storage system, comprising:
receiving a first score for a first characteristic associated with a user and a second score for a second characteristic associated with the user;
evaluating the first score and the second score for determining a first metric for the user;
detecting a criterion for reevaluating the first metric;
based on detecting the criterion, selecting a first action and a timing of the first action for obtaining information associated with the user, wherein the selected first action and timing of the first action are configured to maximize accuracy of a prediction of a second metric for the user and minimize a cost associated with the first action;
generating the second metric based on the information obtained via the first action; and
performing a second action associated with the user based on the second metric.

18. The non-transitory computer readable storage media of claim 17, wherein the first score is generated by a first machine learning model and the second score is generated by a second machine learning model, wherein the first machine learning model and the second machine learning model are different models.

19. The non-transitory computer readable storage media of claim 17, wherein the criterion is detected in response to the first score or the second score being greater than a threshold score, or in response to the first metric being different from a target metric.

20. The non-transitory computer readable storage media of claim 17, wherein the selecting of the first action and the timing of the first action includes:
identifying one or more features of the user;
providing the one or more features to a machine learning model; and
receiving from the machine learning model identification of the first action and the timing of the first action.
